(19) United States
(12) Patent Application Publication
(10) Pub. No.: US 2013/0146491 A1
(43) Pub. Date: Jun. 13, 2013

(54) SELECTIVE EXPOSURE WATERPROOF CASE FOR ELECTRONIC DEVICES

(71) Applicants: Peter Ghali, Washington, DC (US); Jay Huntington, Crownsville, MD (US)

(72) Inventors: Peter Ghali, Washington, DC (US); Jay Huntington, Crownsville, MD (US)

(21) Appl. No.: 13/630,540

(22) Filed: Sep. 28, 2012

Related U.S. Application Data
(60) Provisional application No. 61/650,416, filed on May 22, 2012.

(51) Int. Cl. G06F 1/16; B65B 5/04

(52) U.S. Cl. CPC G06F 1/1626; B65B 5/04
USPC 206/320; 53/472

(57) ABSTRACT

A protective enclosure for a device such as a smart phone has a shell and a gasket configured to be disposed between the shell and the device. The shell is configured to apply a compressive force to the gasket when the gasket is disposed between the shell and the device. The shell has a shell orifice and the gasket has a corresponding gasket orifice. The compressive force applied by the shell and device to the gasket creates a watertight seal around the perimeter of the shell and gasket orifices, preventing water from traversing that perimeter and entering the shell.

This application claims the benefit of U.S. provisional patent application No. 61/650,416, filed May 22, 2012, which is hereby incorporated by reference in its entirety.

### FIELD

This disclosure describes herein a waterproof enclosure. More specifically, this disclosure describes a waterproof case for electronic devices.

### BACKGROUND

Waterproof containers are used to protect devices from the risk of water exposure. They may be used in aquatic surroundings like the beach, swimming pool, or on a boat. Conventionally, waterproof containers protect devices by entirely or completely isolating the device from water. In conventional waterproof containers no portion of the device becomes wet or contacts water if submerged into a body of water. These designs are bulky and suffer from a lack of responsiveness.

Needs exist for improved waterproof protection methods and devices.

### SUMMARY

Example embodiments disclosed herein describe devices, methods, systems and apparatuses that are configured to provide protection for devices without entirely containing or isolating the device. More specifically, embodiments provide a seal, case or enclosure for the device by utilizing the device's body in a manner that protects portions of the device that are susceptible, disposed or prone to damage if they come into contact with elements, such as water, sand, and/or dirt. The protective enclosure is also configured to allow for selective water contact to the device on portions of the device that are impervious, resistant or unaffected by elements.

Accordingly, embodiments are related to an enclosure with a minimalist design and minimized proportions that does not fully encompass a device. Therefore, embodiments are configured to allow for direct contact to a device, and more responsive interaction with portions of a device's interface that are resilient or resistant to elements while the device is positioned in the protective enclosure.

A new protective enclosure for a device has a shell and a gasket configured to be disposed between the shell and a device. The shell is configured to apply a compressive force to the gasket when the gasket is disposed between the shell and the device. The shell has a shell orifice and the gasket has a corresponding gasket orifice. The compressive force applied by the shell to the gasket creates a watertight seal around the perimeter of the shell and gasket orifices, preventing water from traversing that perimeter and entering the shell.

The shell and gasket orifices may be configured to permit user interaction with at least a first interface of the device. The first interface may be a touch screen. The shell orifice and the gasket orifice may be configured to permit water to contact the device—in that case, there are no layers under or over the orifices that would prevent water from contacting the device through the orifices. The shell and gasket may be configured to allow water to contact a back of the device and a touch screen of the device, for example for most smart phones substantially the entire back side can be left exposed to water, as well as the entire front touch screen.

The gasket may include rubber, silicone or PVC. The shell may include a second shell orifice and the gasket may include a rubber protrusion configured to extend through the second shell orifice and interact with a button of the device. The device may be a mobile telephone, computer, camera, tablet computer or media player.

The shell may also include a second shell orifice associated with a second interface, and there may be a waterproof assembly disposed beneath the second shell orifice and between the gasket and the shell that permits transmission of light or sound. The waterproof assembly may include a transparent window having an opening, waterproof fabric over the opening, and a plastic cover over the waterproof fabric and transparent window, and the transparent window, waterproof fabric, and plastic cover of the waterproof assembly may be fused together and to the shell in a watertight fashion.

The shell may include a first portion and a second portion. The first portion or the second portion of the shell may have a coupling protrusion and the other portion of the shell may have a coupling notch. The coupling notch is configured to receive the coupling protrusion to couple the first portion of the shell and the second portion of the shell and to apply compressive force to the gasket. The first or second portion of the shell may be configured to cover a back side of the device, and the other portion of the shell may be configured to cover a front side of the device. Alternatively, one portion may cover the top half and the other the bottom half, one portion may cover the left side and the other the right side, etc. The first portion and the second portion of the shell may have openings configured to receive screws and allow the screws to contact the gasket in positions that do not affect the watertight seal.

The shell may have a thickness of 1 mm to 1.5 mm. The gasket may include or be one or more O-rings. A hinged door may be connected to the shell and configured to releasably connect to the shell and have a charge port gasket that forms a seal between the shell and a charge port when the hinged door is closed.

A new protective enclosure has a shell including a rigid material, having at least one shell orifice configured to permit user interaction with at least a first interface of a device and a gasket including flexible material and including a gasket orifice corresponding to the shell orifice. The gasket is configured to be disposed between the shell and the device, and to receive compressive force from the shell and the device along a perimeter of the shell orifice and the gasket orifice. The gasket and the shell may prevent water from traversing beyond a perimeter of the shell orifice and the gasket orifice.

In a new device protection method, a device is inserted in a protective enclosure, where the protective enclosure includes a gasket fixed to the inside of a shell and has one or more orifices extending through the gasket and shell, a compressive force is applied to the gasket with the shell, forming a waterproof seal around the perimeter of the orifices, and portions of the device are exposed to an environment. Exposing portions of the device to the environment may include exposing one or more interfaces of the device to the environment.

### BRIEF DESCRIPTION OF THE DRAWINGS

The features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 depicts an embodiment of a protective enclosure.

FIG. 2 depicts an embodiment of a protective enclosure for a device including an outer shell and gaskets.

FIGS. 3A-H depict various views of part of an outer shell according to an embodiment.

FIG. 4 depicts a screw cap according to an embodiment that can be used to plug a headphone jack port.

FIGS. 5A-F depict various views of another part of an outer shell according to an embodiment.

FIGS. 6A-B depict views a gasket that may be configured to be disposed between a portion of an outer shell and a device.

FIGS. 7A-F depict views of another gasket that may be configured to be disposed between a portion of an outer shell and a device.

FIGS. 8A-B depict detailed views of a hinged door according to an embodiment.

FIG. 9 depicts a detailed view of a tongue and groove mechanism according to an embodiment.

FIG. 10 depicts a waterproof assembly according to an embodiment.

FIG. 11 depicts an embodiment of a protective enclosure including a waterproof assembly, gasket and outer shell.

FIGS. 12A-12B depict a protective enclosure having posts and corresponding cutouts, according to an embodiment.

FIG. 13 depicts a detailed view of posts having perimeter lips, according to an embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. The existence of any given numbered element does not imply the existence of any other numbered element in the same embodiment, for example a third element does not imply the existence of a second element in a given embodiment. The term “third element” may simply be used to distinguish from a first element or second element in a different embodiment. The terms front and rear are used for convenience and are not limiting. The interfaces and associated orifices and enclosure parts may be on any side of a device. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should be understood that the term device as used herein may be associated with any form of mobile electronic devices, such as a telephone, tablet computer, camera, laptop computer, media player, etc. It should be understood that the term interface may refer to at least one of a touch screen, keyboard, button, antenna, Bluetooth communications hardware, motion sensor, microphone, headset port, data port, charger port, memory port, ear piece, speaker, etc. Accordingly, the term interface may refer to any apparatus configured to communicate data, sound, light, signals, and/or power. It should be understood that the term container, may refer to any type of enclosure, case, housing, shell, hollow, bag, envelope, package, or any other structure or apparatus that contains a device entirely within its internal area. Furthermore, it should be understood that the term elements may be used to describe at least one of water, sand, dirt, dust, etc.

Embodiments herein disclose a protective enclosure for a device. The protective enclosure may be configured to protect or guard a device from being exposed to elements, such as water, sand, and dirt while allowing a user direct access to the device's interfaces. More specifically, the protective enclosure may offer a degree of protection that is designated by International Protection Standard (IP) Level 68, as defined by International Standard IEC 60529. IP Level 68 is characterized by complete protection against ingress of dirt and sand, and can withstand continuous water submersion beyond one meter in depth. The protective enclosure need not be permanently attached to or a part of the device, but can be retrofitted onto and sold separately from existing devices and applied and removed as desired.

Waterproof containers may be used to protect a device from being exposed to water particularly in aquatic areas. Conventionally, containers or cases protect a device from exposure to water by completely enclosing the device. The enclosures may allow access to a touch screen or interface of the device by touching a transparent and impermeable membrane, skin or cover disposed over the entire device. The membrane may reduce, limit, inhibit or isolate water from entering the container. Accordingly, a user may interact with the device's user interface through the membrane. Thus, conventional mechanisms and cases for providing water protection for a device fully encompass the device.

Embodiments provide a protective enclosure for a device by utilizing the device's body in a manner that protects portions of the device that are susceptible, disposed or prone to damage if they come into with elements, while allowing for selective water contact to the device on portions of the device that are impervious, resistant or unaffected by elements.

More so, embodiments of the protective enclosure utilize a system of gaskets disposed between an outer shell of a case and the device. Compressive force may be applied to the system of gaskets via the outer shell and the device, such that the gaskets limit, reduce or prevent water from entering portions of the device that would otherwise be susceptible to water damage. The gasket(s) may be permanently attached to the shell, for example by adhesive or other bonding, and a user needs only to insert a device into the shell/gasket combination and secure the shell/gasket around the device.

Therefore, the protective enclosure is configured to allow for direct user interaction with interfaces on the device while protecting the device from the elements. Accordingly, embodiments disclosed herein provide a protective enclosure that does not fully encompass, cover or contain the device.

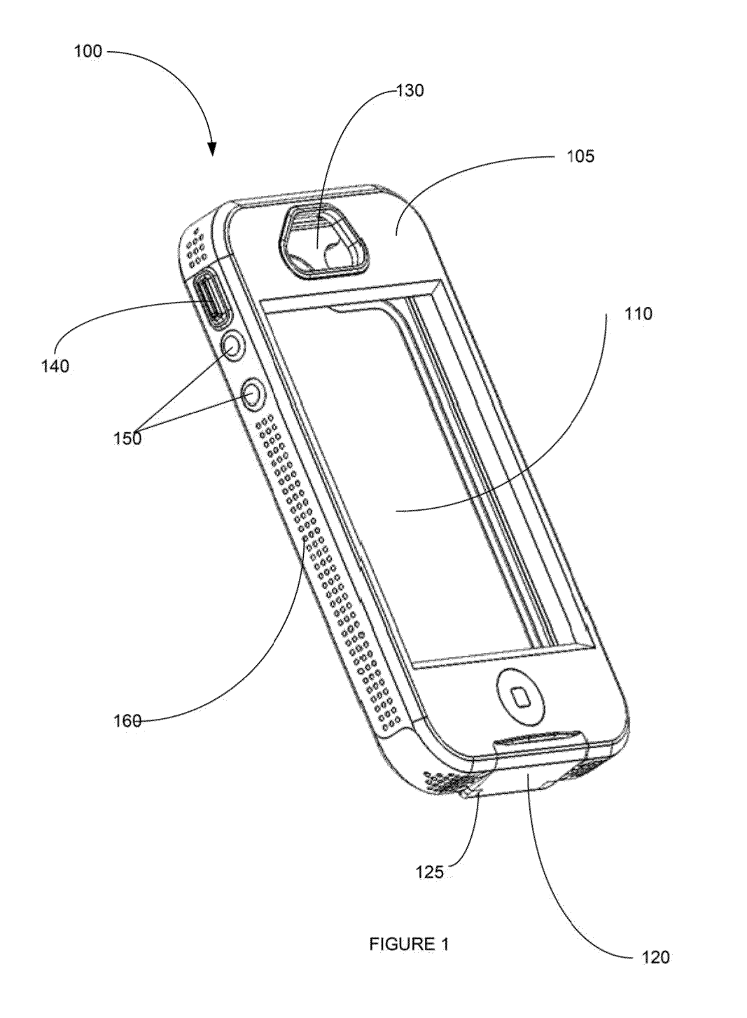

Turning to FIG. 1, FIG. 1 depicts a protective enclosure 100 in an isometric view. Protective enclosure 100 may be configured to offer protection from elements, such as water, while allowing interaction with at least one of the device's interfaces.

Protective enclosure 100 may be comprised of any waterproof rigid material, such as aluminum, plastic, etc. Aluminum is a good material for withstanding the compressive forces of underwater use, and is also lightweight and attractive. Protective enclosure 100 may include a covering portion 105, orifices 110, 130, 140, 150, 160, and door 120.

Covering portion 105 may be configured to cover, encompass, or conceal a portion of a device (not shown) that does not include an interface, or does not transfer or communicate sound, light or power. As such, covering portion 105 may be configured to cover any portion of the device that is not associated with an interface.

Door 120 may be configured to cover a power port of the device. Door 120 may include a hinge 125 on a first side of the door 120. Further, hinge 125 may be coupled to the protective enclosure 100 such that door 120 may be snapped open and closed. In further embodiments, a rubber gasket on the inside of the door may be used to prevent water from reaching the power port of the device when door 120 is in a closed position.

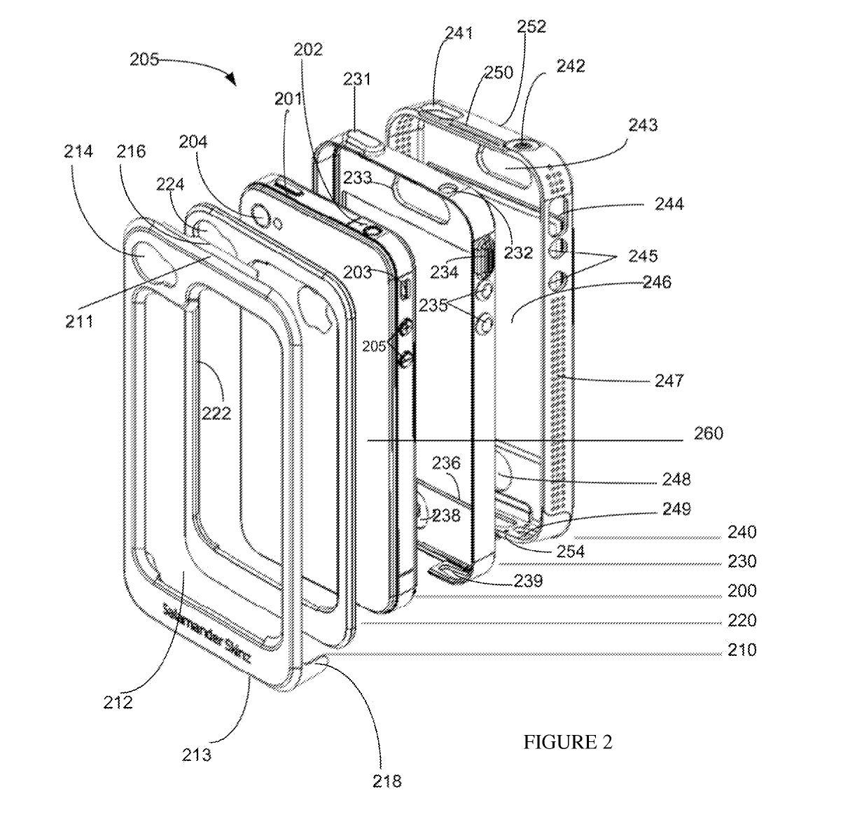

Orifices 110, 140, 150 may be cut-out portions of protective enclosure 100 that are overlaid on interfaces. The orifices may expose an internal layer such as a gasket or lens assembly. Further, each of orifices 110, 140, 150 may correspond with a different interface on a device that is impervious, resistant or resilient to elements. For example, orifice 110 may be associated with a touch screen, orifice 140 may correspond with a mute switch and orifice 150 may be associated with volume control buttons for the device. Because a surface of certain interfaces may be waterproof, such as a touch screen that is comprised of ceramic glass, the interface may need not be obscured, obstructed and/or covered by any portion of protective enclosure 100 or any protective cover. Accordingly, during submersion water may contact the touch screen. However, by protective enclosure 100 applying compressive force along a perimeter of the orifices 110, 140 and 150 to a system of compressed gaskets (as discussed in FIG. 2), the protective enclosure 100 may limit, reduce or prevent water from traversing the perimeter of the orifice 110, 140, 150 and touching a device. In other words, protective enclosure 100 may allow water to selectively contact an interface associated with orifices 110, 140 or 150 without contacting any other portion of the device.

Orifices 130 and 160 may be cut-out portions of protective enclosure 100 that are overlaid on interfaces of a device that are not impervious, resistant or resilient to elements. For example, orifice 130 may be associated with a front facing camera, ear piece, and proximity sensor, and orifice 160 may be associated with a phone's antennae. As discussed in FIG. 2, gaskets, liner and/or a breathable waterproof fabric material may be disposed between orifices 130 and 160 and the device. Gaskets may be a flexible material such as rubber, silicone or PVC. Therefore, the compressive force applied by protective enclosure 100 along a perimeter of orifices 130 and 160 may repel water while allowing sound, signals, light, and/or capacitive fluctuations to be communicated, received, or transmitted by the interfaces associated with orifices 130 and 160. For example, between orifice 130 and the device, gaskets and a waterproof fabric may be configured so sounds from an earpiece speaker may traverse through the gasket, waterproof fabric, and orifice 130 of the protective enclosure 100 so that a user may hear the sounds. Further, the gasket and waterproof fabric may protect the speaker from coming into contact within water. Similarly, a microphone for the device may receive sounds while also being protected from water damage.

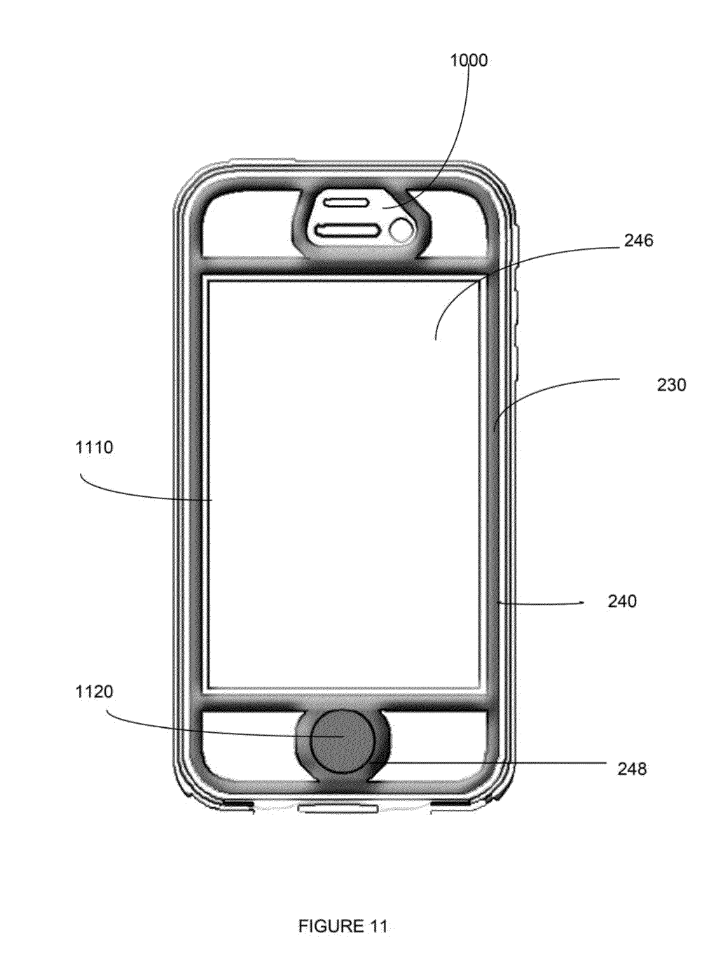

FIG. 2 depicts an exploded view of protective enclosure 205 for device 200. Protective enclosure 205 may include a rear outer shell 210, a front outer shell 240, a rear gasket 220 and a front gasket 230. In this embodiment, gaskets 220, 230 are quite extensive, however in certain embodiments they be quite reduced in volume/device surface area coverage. Depending on the type of material and shape of the gaskets that are used, such extensive coverage may result in some undesirable flexing of the gasket in operation (e.g. due to flat gaskets having nowhere to readily displace). In that scenario, or to reduce weight or for other reasons, the gaskets may be reduced in size to cover primarily the perimeters of the orifices in the outer shells 210, 240, as well as the join between the shells, for example as shown in FIG. 11, or to something between the coverage shown in FIG. 11 and in FIG. 2. To seal off sensitive areas of the device, it is typically necessary to seal certain interfaces such as speakers, microphones and buttons, as well as any seams or joins in the device where water could penetrate to the interior under pressure.

Rear outer shell 210 may be comprised of a rigid and waterproof material, for example aluminum or plastic, and may be between one millimeter and one and a half millimeters. Rear outer shell 210 may include orifices 212 and 214. Further, rear outer shell 210 may be configured to be disposed on a back side 260 of device 200. More specifically, rear outer shell 210 may be configured to be disposed on a side of device 200 that may not include a graphical user interface, display or screen. Orifice 212 may be cut-out portion of rear outer shell 210, and may be configured to be overlaid on a portion of device 200 that that is impervious, resistant or resilient to elements. For example, orifice 212 may cover a back side 260 of device 200. Because back side 260 of device 200 may be waterproof the back side 260 of device 200 may need not be obscured, obstructed and/or covered by any portion of protective enclosure 205 such as rear outer shell 210 or any protective cover. Accordingly, during submersion water may contact back side 260 of device 210. Orifice 214 may be a cut-out portion of rear outer shell 210 that is over an interface. Further, orifice 214 may correspond to an interface that is not impervious, resistant or resilient to elements. For example, orifice 214 may be associated with a rear facing camera 204 of device 200. However, by disposing orifice 214 over an interface that requires or desires the transmission of light (i.e., rear facing camera 204), interfaces of device 200 may still be used, while device 200 is disposed within protective enclosure 200.

Front outer shell 240 may be comprised of a rigid and waterproof material, for example aluminum or plastic, and may be between one millimeter and one and a half millimeters. Further, front outer shell 240 may be configured to be disposed on a front side of device 200. More specifically, front outer shell 240 may be configured to be disposed on a side of device 200 that may include a graphical user interface, display or screen.

More so, front outer shell 240 may include orifices 241-249. Each of the orifices 241-249 may be associated with a different interface of device 200. For example, orifice 241 may be associated with a power button of device 200, orifice 242 may be associated with a headset jack port of device 200, orifice 243 may be associated with a motion sensor, earpiece, and front facing camera (not shown) of device 200, orifice 244 may be associated with a mute switch 203 of device 200, orifices 245 may be associated with volume controls 205 of device 200, orifice 246 may be associated with a touch screen device (not shown) of device 200, orifices 247 may be vents that are configured to allow radio frequency signals to be transmitted through the protective enclosure, orifice 248 may be associated with a menu button of device 200, and orifice 249 may be associated with a microphone for device 200. Some metal casings may interfere with the reception of certain electronic devices, and holes 247 in the sides of the shell where the antennae are located can reduce or eliminate this interference. In some embodiments, these numerous small holes may be replaced by larger cut-outs, for example a single large box cut-out in each side. Such larger cut-outs can be even more effective at transmitting RF signals without degradation. Because the interfaces of device 200 correspond with orifices 241-249 within front outer shell 240 the interfaces may be used without contact from front outer shell 240. For example, a user may directly touch a touch-screen of device 200 through orifice 241 with the user's fingers or a stylus pen.

Rear outer shell 210 and front outer shell 240 may be configured to be coupled together via a tongue 216 and groove 250 system. More specifically, tongue 216 may be a projection on a top surface 211 of rear outer shell 210, and groove 250 may be a notch disposed within a top surface 252 of front outer shell 240. Tongue 216 may be configured to be received by groove 250 to couple rear outer shell 210 and front outer shell 240. The absence of a hinged connection minimizes overall dimensions of the enclosure 100. In alternative embodiments, a hinge or other latching structure or fastening structure may be used. Once coupled, rear outer shell 210 and front outer shell 240 may apply compressive force toward device 200 through gaskets 220, 230 by pressing the gaskets 220, 230 against the device 200. More specifically, compressive force may be applied on the perimeters of each of the orifices on rear outer shell 210 and front outer shell 240. The shells 210, 240 are configured such that they do not leave sufficient room between the shells 210, 240 and the device 200 when coupled for gaskets 220, 230 to be positioned in between in a relaxed state.

On a bottom surface 213 of rear outer shell 210 may be projections 218 with orifices and on a bottom surface 254 of front outer shell 240 there may be holes configured to receive screws. Projections 218 may be configured to be disposed within front outer shell 240 and on top of the holes configured to receive screws on bottom surface 254. Once projections 218 are disposed within front outer shell 240, screws may be inserted through the holes in bottom surface 254 fastened to device 200 and corresponding holes in projections 218 to further couple rear outer shell 210 with front outer shell 240. The screws in this embodiment extend only through the shells 210, 240, and do not extend through them to the gasket. As a result, the tightness of the screws does not affect the compression force on the gaskets, which is instead determined by the space between the outer shells and the device and the size and hardness of the gaskets, which are essentially constant. Thus, a specific amount of compressive force can be achieved that does not vary based on the tightness of the screws and maintains the waterproof nature of the enclosure.

Rear gasket 220 may be a flexible material, such as rubber, configured to receive compressive force from rear outer shell 210 and device 200. Further, rear gasket 220 may be configured to prevent, limit or reduce water traversing beyond a perimeter of one of the orifices within rear outer shell 210 via the compressive force applied on the perimeters of the orifices on rear gasket 220. Also, rear gasket 220 may be disposed between device 200 and rear outer shell 220, and may have orifices 222 and 224 that correspond with orifices 212 and 214 of rear outer shell 210. Therefore, if rear gasket 220 is positioned between rear outer shell 210 and device 200, rear facing camera 204 may operate in a normal fashion, and no portion of rear gasket 220 or rear outer shell 210 may contact rear facing camera 204. In other embodiments, the gaskets may not have orifices corresponding with one or more of the outer shell orifices.

Front gasket 230 may be a flexible material, such as rubber, configured to be substantially the same shape as front outer shell 240, such that front gasket 230 may be disposed between front outer shell 240 and device 200. More so, gasket 230 may be configured to receive compressive force from front outer shell 240 and device 200 if front outer shell 240 is coupled to rear outer shell 210. By applying compressive force to front gasket 230, front gasket 230 may be configured to prevent, limit or reduce water traversing beyond a perimeter of one of the orifices within front outer shell 240 via the compressive force applied on the perimeters of the orifices on front gasket 230.

Front gasket 230, corresponding to front outer shell 140, may extend along the sides of the device 200 as shown, with rear gasket 220 extending only on the back side of the device. When the front and rear outer shells 210, 240 are coupled, front and rear gaskets 220, 230 are pressed together at the back of the side of the device. The two gaskets pressing against one another creates a seal at the join of the outer shells. The device body 200 prevents side-to-side displacement of the gaskets and forces them tightly against each other. In some embodiments, the front or rear gasket may be replaced at the intersection of the two gaskets with a metal ridge. The remaining gasket presses against the ridge to create the seal, and the more-rigid ridge will not flex as a gasket may under some circumstances.

Front gasket 230 may be disposed between device 200 and front shell 240, and may have orifices 232, 233, 236 and 239 that correspond with orifices 242, 243, 246 and 249 of front outer shell 240 respectively. Therefore, if front gasket 230 is positioned between front outer shell 240 and device 200, a user may directly touch and use interfaces, such as a touch screen through orifices 236 and 246, on the front side of device 200. More so, orifice 232 may be an orifice corresponding to headset adapter port 202 of device 200. A threaded cap 400 (shown in FIG. 4) may be inserted through orifices 232 and 242 into the headset adapter port 202. This cap 400 may have a grippable top such that it is easily inserted and removed by hand without the use of a screwdriver or other tool, and may have an O-ring under the top/head portion to effect a tight seal. The threaded cap may be removed and/or inserted based on whether the headset adapter port 202 of device 200 is in use.

Front gasket 230 may also have projections 231, 234, 235 and 238. Projections 231, 234, 235 and 238 are configured to traverse through a respective orifice 241, 244, 245 and 248 of outer shell 240. More so, projections 231, 234, 235 and 238 may be rubber protrusions configured to interact with, cover and/or protect at least one of an interface, switch and/or button of device 200, such that a user may press, slide, or perform any other desired action on projection 231, 234, 235, 238 to cause device 200 to perform an action associated with the interface, switch and/or button. For example, a user may press projection 231 extending through orifice 241 to cause power button 201 to turn on device 200.

Accordingly, rear gasket 220 and front gasket 230 may be configured to act as a rubber membrane between rear outer shell 210 and front outer shell 240. Protrusions of rear gasket 220 and front gasket 240 may be disposed flush with rear outer shell 210 and front outer shell 240, respectively. The compressive force on rear gasket 210 and front gasket 240 may prevent, limit, or reduce water from traversing to portions of device 200 that are not resilient, resistant, and/or impervious to water. This orifice/protrusion structure may be used for all buttons and switches, including power/standby, volume, main (round) button, mute switch, etc.

Upon the rear outer shell 210 and front outer shell 240 being coupled together, rear gasket 220, device 200, and front outer shell 230 may be disposed between rear outer shell 210 and front outer shell 240 to create a unified appearance.

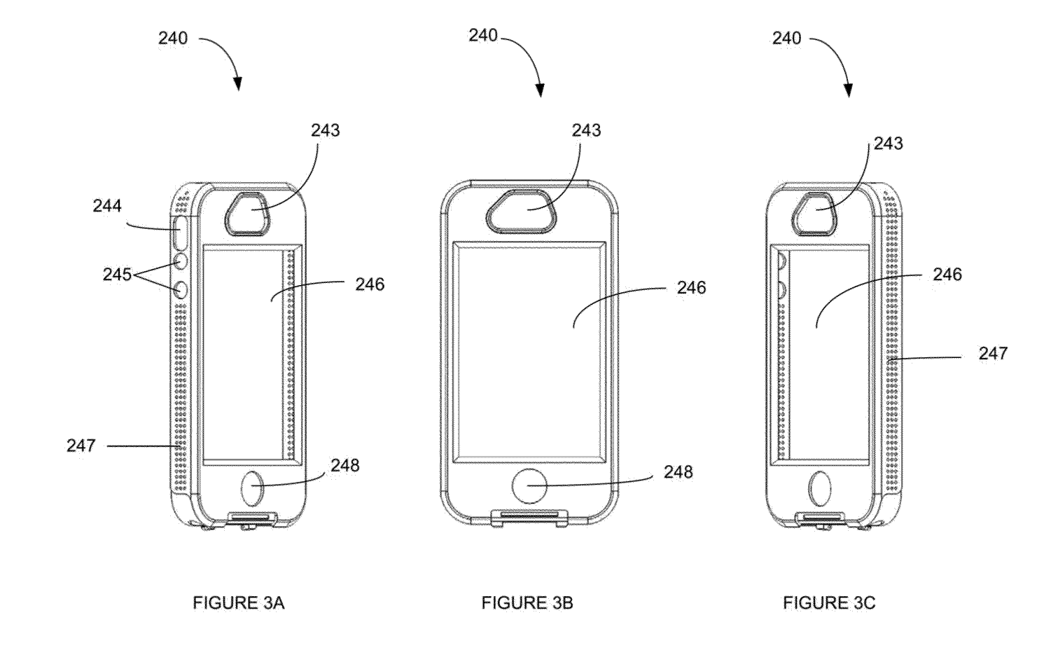

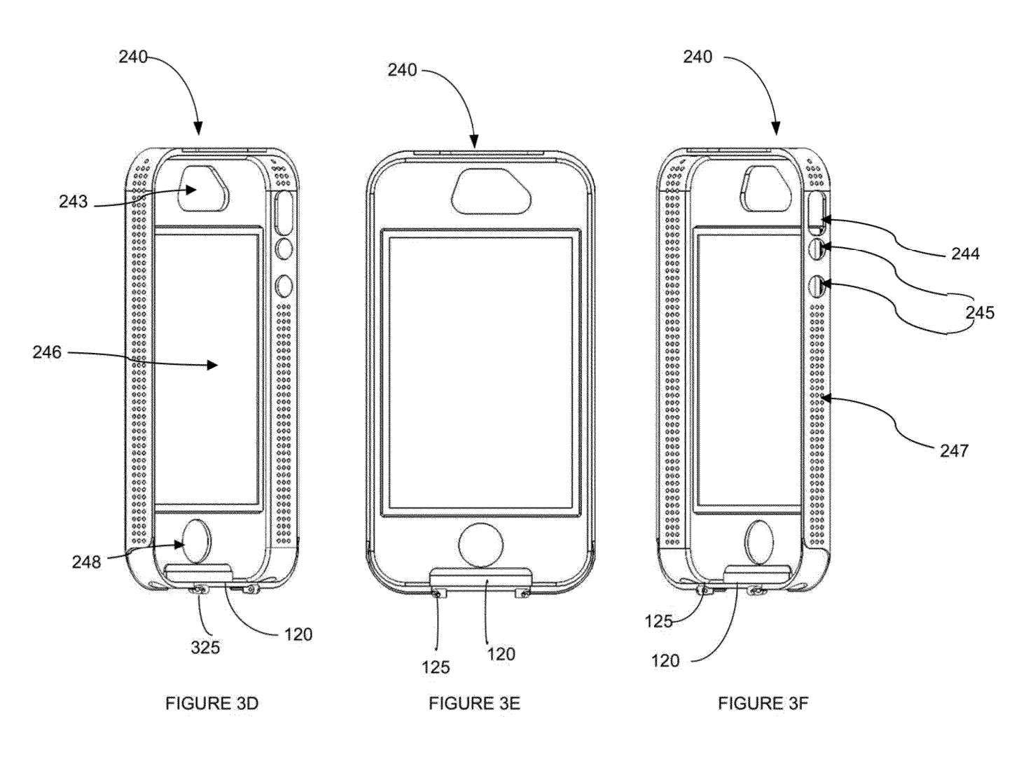

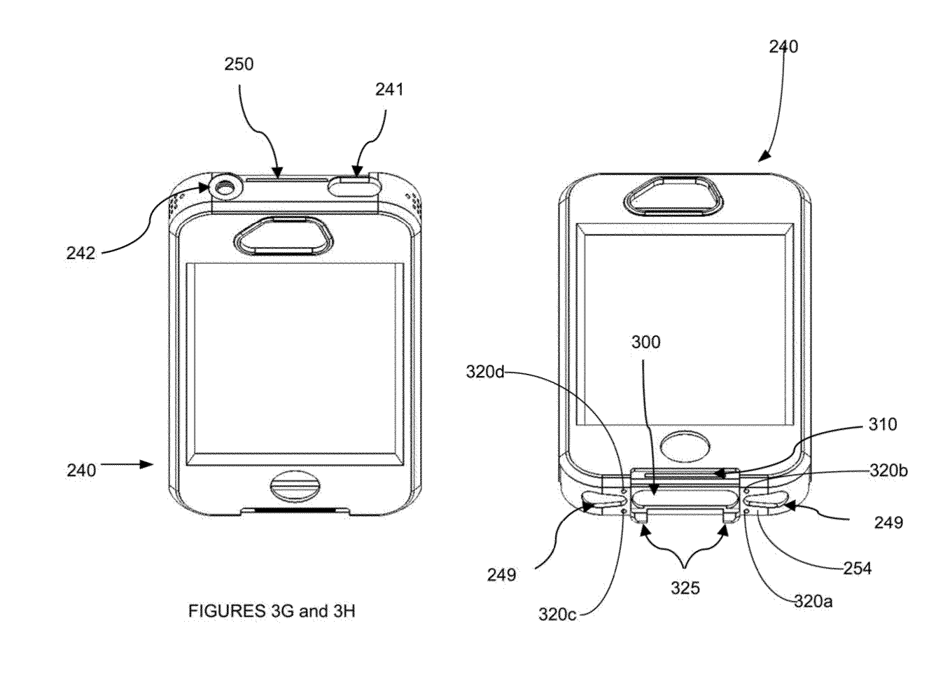

FIGS. 3A-C depict front side views of front outer shell 240. As shown in FIGS. 3A-C, orifices 243-248 are cut out portions of outer shell 240. FIGS. 3D-F depict back side views of front outer shell 240.

FIGS. 3G-H depict a top view and a bottom view of front outer shell 240. Outer shell 240 may include orifices 249, 300 and 320a-d, hinge receivers 325 and groove 310. Orifice 300 may be disposed on bottom surface 254 of front outer shell 240, and may be configured such that a charging cord may traverse through orifice 300. Orifice 249 may be configured to be disposed over a microphone of a device, such that sound may traverse through orifice 249 (e.g. through a waterproof fabric layer below). Orifices 320a-d may be threaded holes configured to each receive a screw, such that screws may be inserted within orifices 320a-d to further couple outer shell 240 to outer shell 210. Hinge receivers 325 may be configured to be coupled with a hinge for a door. Groove 310 may be configured to receive a projection of a door. Accordingly, if a projection of a door is within groove 310 the door may be in a closed position covering orifice 300, and if the projection of the door is not within groove 310 the door may be in an open position allowing a charging cord to traverse orifice 300.

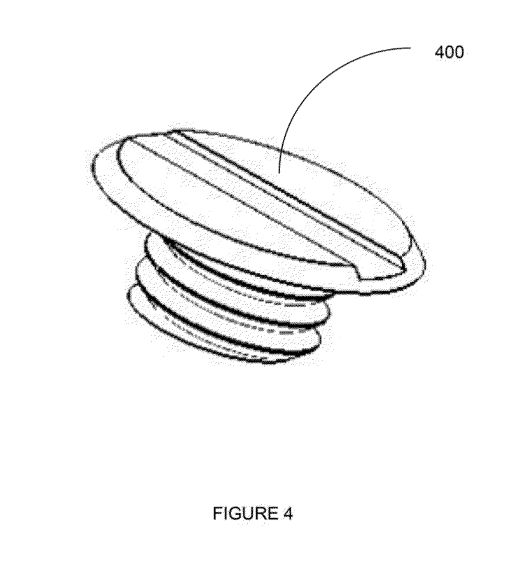

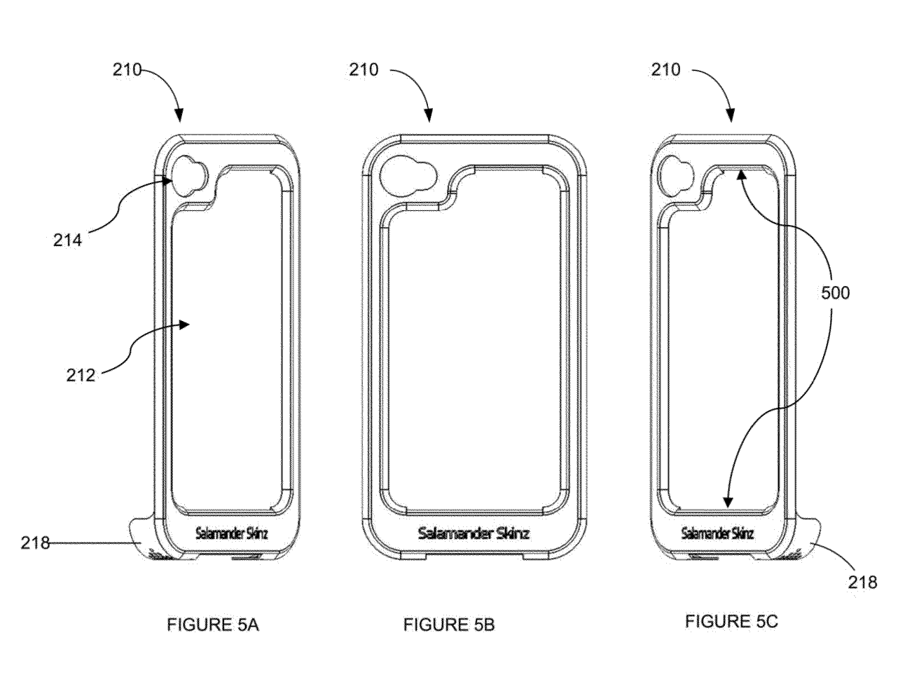

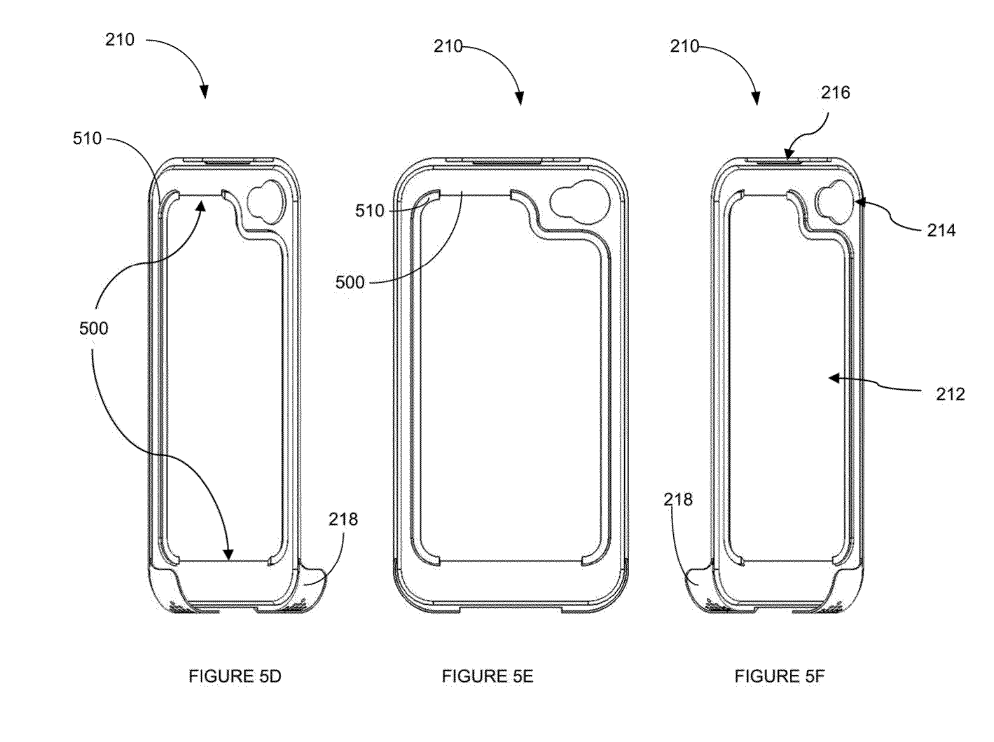

FIGS. 5A-5C depict a front side view of rear outer shell 210 and FIGS. 5D-F depict a back side view of rear outer shell 210. Here, rearward protrusions 510 can be seen. The edges of the gasket (around the perimeter of its orifice) remain on the inside of this protrusion so that they are not visible around the edges of the shell orifice when the shell is installed on a device. The gasket is thicker than the protrusion, extending for example half a millimeter beyond the top of the protrusion, which may be for example 1 mm high. Thus, the protrusion will not affect the compressive force on the gasket and resulting seal.

Furthermore, FIGS. 5C and 5D include adapter mounting zones 500 at the top and bottom of orifice 210. Adapter mounting zone 500 is a break in the perimeter protrusion 510 that allows a removable adapter to be secured to the enclosure without compromising the waterproof seal. For example, a padded insert can have top and bottom projections that are inserted into the adapter mounting zones 500 to secure the padded insert to the enclosure. The padded insert may be a flexible leather, rubber, neoprene, or similar material. To remove the padded insert, it may be flexed to remove one projection from the adapter mounting zones 500.

This padded insert may have a thickness that extends beyond the thickness of the outer shell, such that when the device is placed on its back on a surface, only the padded insert is in contact with the surface. That avoids wear on the enclosure and, especially for a metal enclosure, also wear on the surface and a harsh impact when setting the device down. It also may be more comfortable in a user's hand and less slippery, and may cause the case and device to float in water, depending on the density and volume of the insert.

In other embodiments, the adapter zones may be closed off. In other words, the protrusion 510 may completely surround the orifice in the shell, however in the adapter zones the protrusion 510 may be set back slightly from the perimeter of the orifice to allow the removable adapter/insert to be inserted. This helps to avoid flexing of the shell under certain conditions (materials, depth underwater, force of compression).

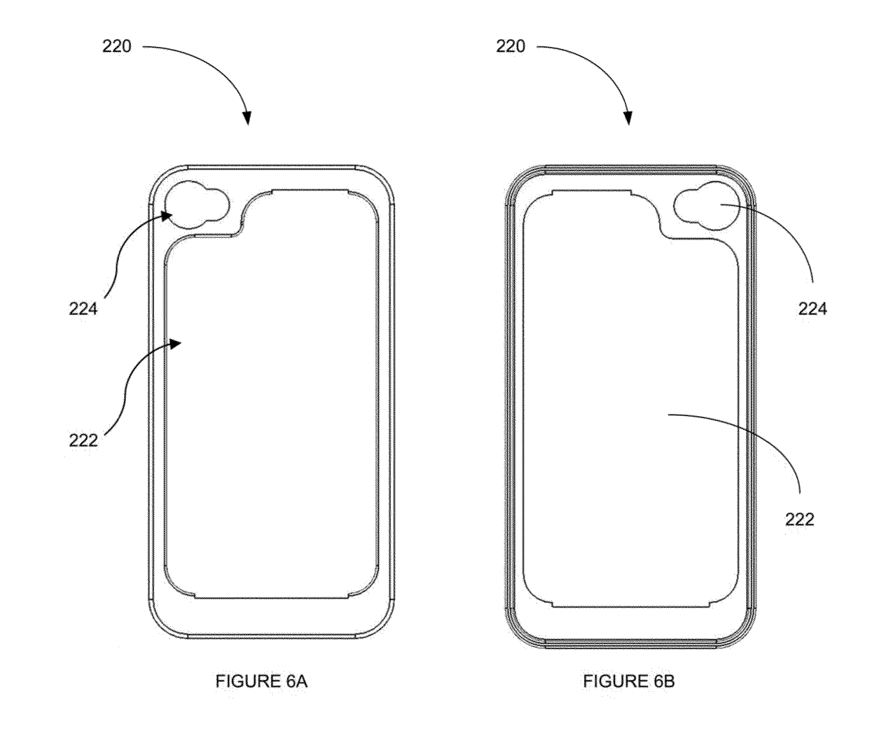

FIG. 6A depicts a front side view of rear gasket 220 and FIG. 6B depicts a back side view of rear gasket 220. As depicted, rear gasket 220 is substantially the same shape as rear outer shell 210. Therefore, compressive force may be applied along the perimeter of orifice 210 to portions of rear gasket 220 such that a watertight seal is formed between a device and rear outer shell 210.

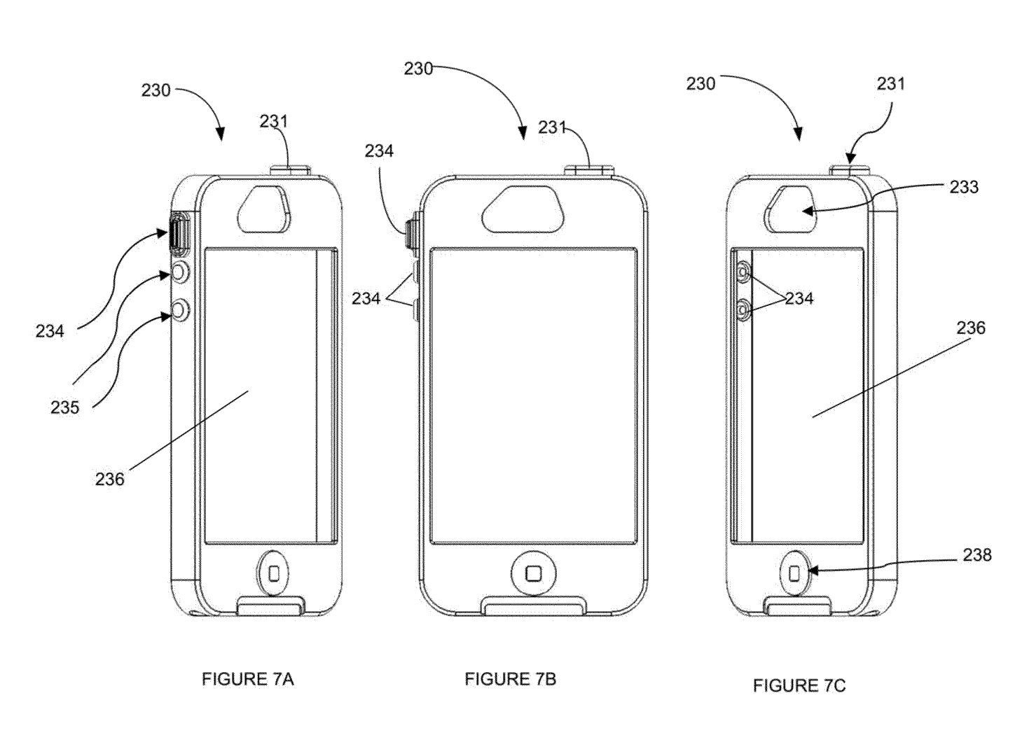

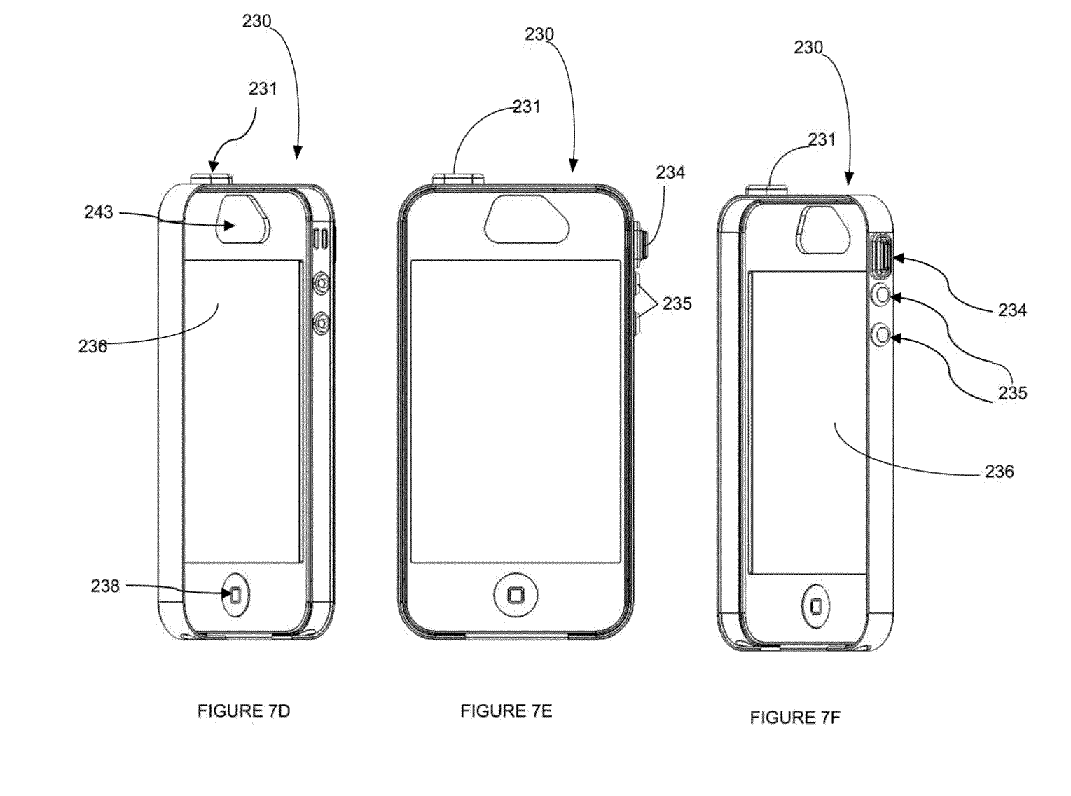

FIGS. 7A-C depict front views of front gasket 230 and FIGS. 7D-F depict back views of front gasket 230. As can be seen in FIGS. 7A-7C front gasket 230 includes projections such as projection 231 that may be associated with a power button of a device. Projection 231 may be configured to be extended through orifice 241 of front outer shell 240. When front outer shell 240 is coupled to rear outer shell 210, compressive force may be applied along the perimeter of projection 231 to form a watertight seal.

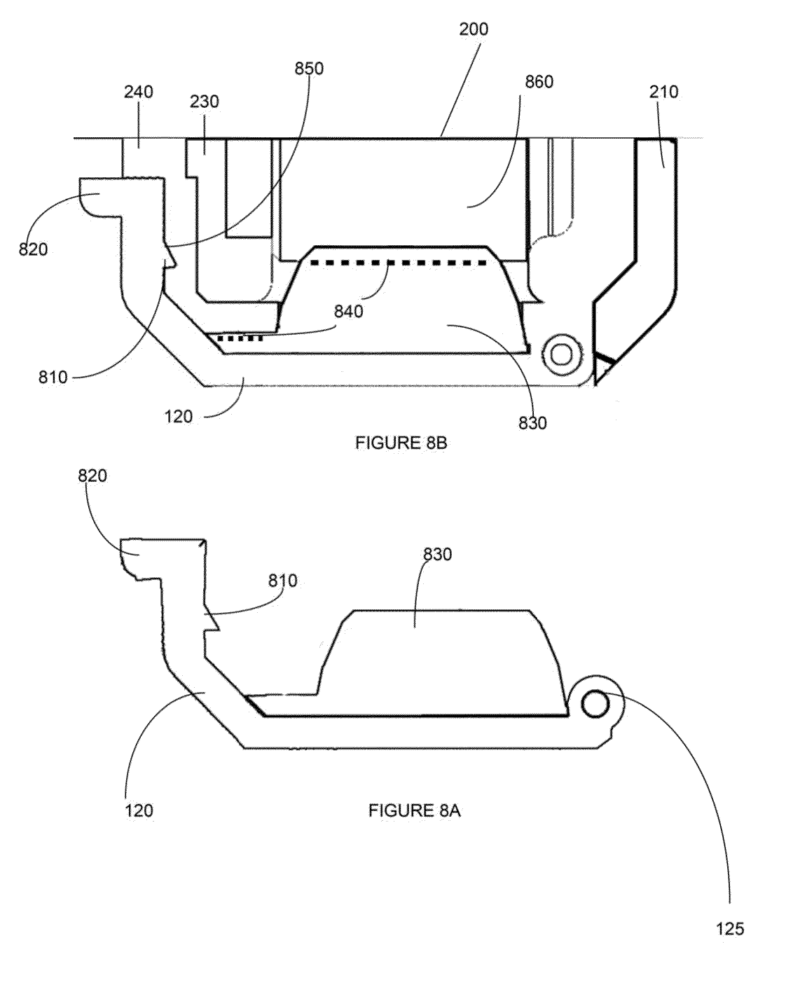

FIGS. 8A and 8B depict an embodiment of door 120. Door 120 may include hinge 125, projection 810, ridge 820 and door gasket 830. Door 120 is attached only to the front outer shell 240 and not to rear outer shell 210, and does not need to be opened in order to remove the device from the shell.

Projection 810 may be configured to be received by groove 850 within front outer shell 240.

Further, groove 850 may be configured to receive projection 810 to secure or couple door 120 to front outer shell 240. Ridge 820 may be a projection that is configured to extend outward from front outer shell 240 when projection 810 is within groove 850, for easy opening of the door 120 by a user. Ridge 820 may be utilized to open, release, couple or close projection 810 with groove 850 to open or close door 120.

Door gasket 830 may be comprised of a flexible material capable of receiving compressive force. If groove 850 is coupled with projection 810, door gasket 830 may be pressed against a charge port 860 of a device 200, and compressive force 840 may be applied to door gasket 830 via door 120 and charge port 860, forming a seal that prevents the entrance of water.

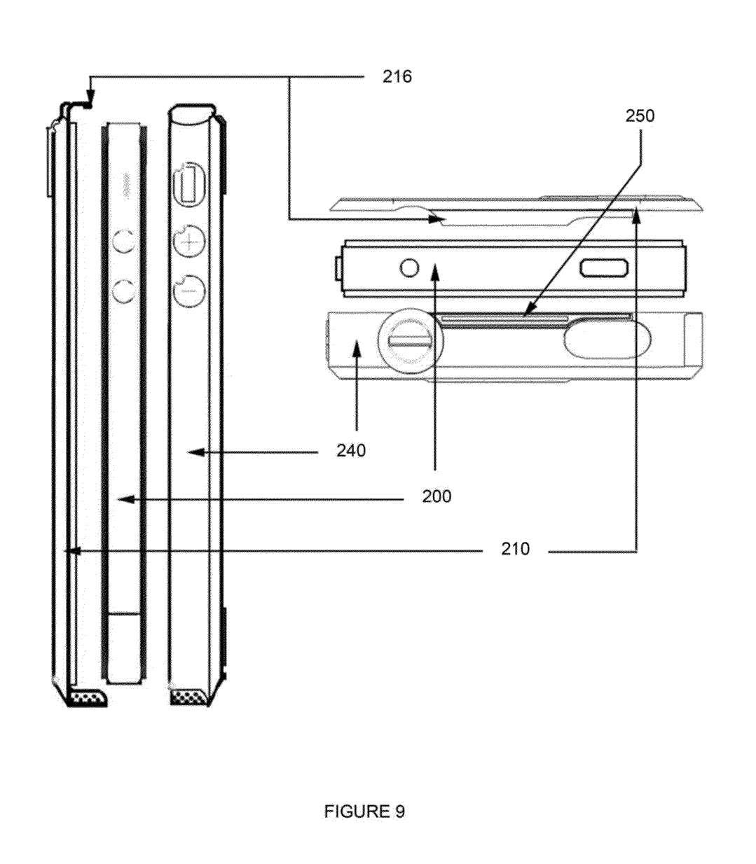

FIG. 9 depicts a tongue 216 and groove 250 mechanism for coupling rear outer shell 210 and a front outer shell 240. Tongue 216 projects outwards from rear outer shell 210 and has a small downward projection that mates with groove 250 in the front outer shell 240. The entire tongue 216 when coupled rests within a depression in front outer shell 240. To couple rear outer shell 210 and front outer shell 240 with a device 200 disposed between them, the downward projection of tongue 216 may be inserted in groove 250 and projections 218 inserted within front outer shell 240 by pressing the two shells together, until screw holes 320 on the projections 216 and front outer shell 240 line up. At that point, screws may be inserted into screw holes 320 to securely couple the outer shells. The shells may not flex sufficiently for tongue 216 to release from groove 250 without removal of the screws.

In another embodiment, the projection of rear outer shell 210 (and correspondingly, the front outer shell 240) may be designed to fir under, rather than over, the top of front outer shell 240, and to have a projection extending upwards, rather than downwards. In that embodiment, the groove 250 in front outer shell 240 faces downwards, rather than upwards.

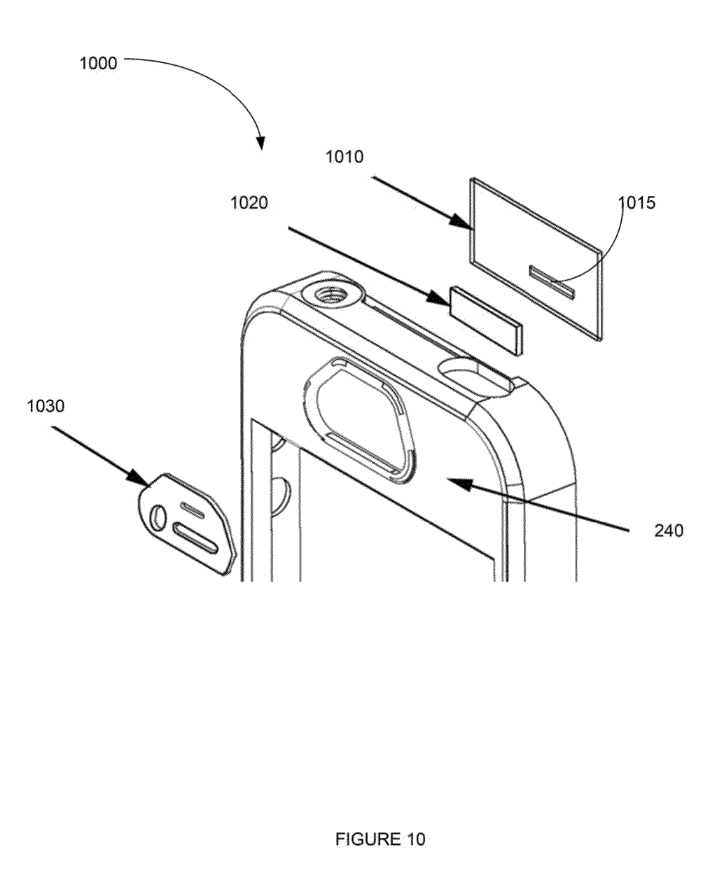

FIG. 10 depicts a waterproof assembly 1000 for an interface of a device. Waterproof assembly 1000 may be configured to cover or be disposed over an interface of a device, such as an optical lens, to protect interfaces of a device that are not resistant or impervious to water or other elements. The waterproof assembly 1000 may include a transparent window 1010, a breathable waterproof fabric 1020 that allows the transport of sound but repels water such as Gortex®, and a plastic cover 1030. The waterproof assembly 1000 may be positioned between rear outer shell 210 and rear gasket 220, and/or front gasket 230 and front outer shell 240.

Transparent window 1010 may be a clear or translucent window with groove 1015. Transparent window 1010 may be configured to be disposed over an orifice of a gasket associated with a desired interface. Further, transparent window 1010 may be configured such that light may traverse transparent window 1010 and be received by an interface such as a camera. Groove 1015 may be disposed within transparent window 1010 to allow sound to traverse transparent window 1010 to be utilized by an interface such as an earpiece.

Waterproof fabric 1020 may be configured to allow sound to traverse the fabric while repelling water, permitting sound to travel through with minimal degradation in audio quality. The waterproof fabric 1020 may be configured to be disposed over groove 1015 of the transparent window 1010.

Plastic cover 1030 may be configured to allow light or sound to be communicated to or from an interface associated with waterproof assembly 1000, and provide a rigid cover to protect an associated or desired interface. Further, plastic cover 1030 may be disposed over window 1010 and waterproof fabric 1020 to create a finished and unified appearance.

For interfaces that do not require sound transmission, the waterproof assembly may exclude the waterproof fabric and groove 1015. The waterproof assembly may be directly attached to the gasket, rather than the shell.

The materials of the waterproof assembly 1000 may be fused or coupled together. In at least one embodiment, the materials of the waterproof assembly 1000 may be coupled or fused together with a heat-induced seal or a waterproof epoxy to create a watertight assembly. Waterproof assembly 1000, may then be fused to an outer shell, such as front outer shell 240 with a heat-induced seal or a waterproof epoxy.

One skilled in the art would understand that the waterproof assembly may be configured to cover each interface on a device that is not resilient, resistant or impervious to water but requires sound and/or light to traverse through a case to operate, or to provide extra protection for waterproof interfaces. Accordingly, one or more waterproof assemblies may be configured to cover a plurality of interfaces for a device. In further embodiments, the waterproof assembly may include a plurality of sheets of waterproof fabric and transparent windows, and each may be configured for a different interface, or may be comprised of a single waterproof fabric configured to cover a plurality of interfaces. Such interfaces may occur on top and bottom surfaces of a device where microphones and speakers exist and on the rear surface for the rear facing camera.

FIG. 11 depicts a front view of front outer shell 240 and waterproof assembly 1000 in an embodiment where front gasket 230 consists of an O-ring 1110. The front gasket is only present around the perimeter of the orifices of the front outer shell 240, as well as around the perimeter of the front outer shell 240 where the outer shells 210, 240 are joined, and compression of the O-ring 1110 is sufficient to prevent water and other elements from entering the front outer shell 240. In the case of the main button, a full gasket 1120 is used to allow for manipulation through the outer shell orifice 248 without water entry. O-rings flatten out when compressed and are less prone to undesirable flexing.

An example embodiment comprises an outer shell made of aluminum. Aluminum or other metals and metal alloys are useful for the shell surface, because the rigidity of those materials supplies consistent and even compressive force along the full perimeter of the LCD window surface. The rigidity of these materials allows the front and back halves to be secured together only at the top and bottom surfaces of the enclosure whilst supplying equal and consistent force throughout interior regions of the front and back shells. This approach can minimize the dimensions of the overall case because very little relative space is required for latching mechanisms.

Those skilled in the art, however, will recognize that alternative embodiments can be created from a more flexible choice of materials. Plastics, polymer resins, and rubber-like materials categorized as thermoplastic elastomers (TPE) can also be used for the outer shell of the enclosure. It may be desirable to use these materials in lieu of metal alloys because they may offer superior impact resistance and less degradation of cellular reception than that introduced with metal alloys. In these alternative embodiments, a different approach may be used for fastening the two halves together, to compensate for the vulnerability created by using a flexible material. In one embodiment that uses a less rigid material, plastic or rubberized fasteners such as snaps or a tongue-and-groove feature may exist along the perimeter of the phone case. These snaps or features can be fashioned to supply constant and even pressure around the perimeter of the cutouts in order to ensure a water-tight seal around the assembly.

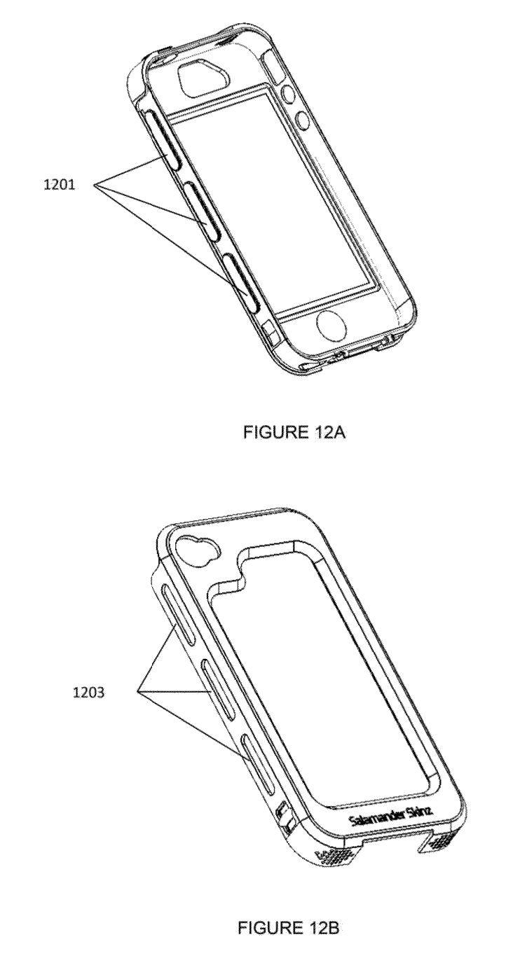

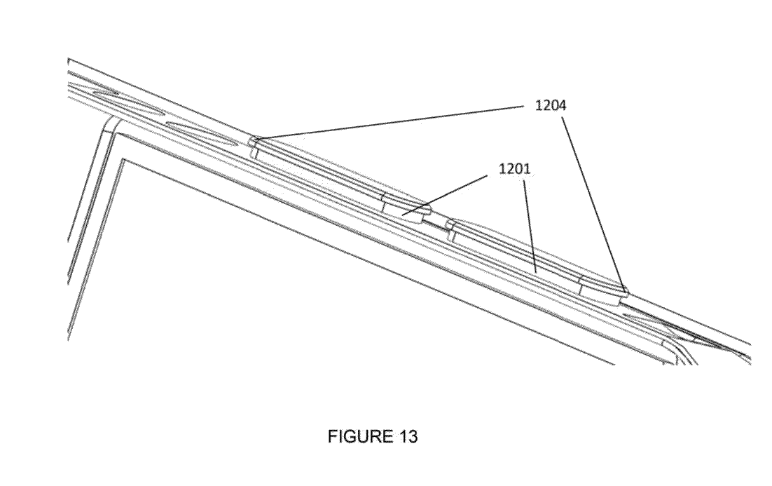

FIGS. 12A and 12B illustrate one such embodiment, having rubber extrusions or posts 1201 in the back half of the assembly (the half that corresponds with the main camera on the phone). The rubber extrusions mate with corresponding cutouts 1203 in the front half of the assembly (the half that encompasses the main LCD window of the phone). When assembled, rubber posts on the back half are inserted through the cutouts on the front half A small perimeter lip 1204 on posts 1201, shown in detail in FIG. 13, exposes a surface area slightly larger than the cutouts 1203, which, when mated, creates a snapping effect. The join between the posts and the cutouts draws the front and back halves of the assembly toward each other in a consistent manner around the perimeter of the assembly.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. For example, various different materials, opening mechanisms for the outer shells, types of gaskets and windows and case configurations can be used. In other instances, well-known structures, components, systems, materials, or operations are not specifically shown or described in detail to avoid obscuring aspects of embodiments. While the embodiments may be illustrated by using a particular embodiment, this is not and does not limit the invention to any particular embodiment and a person of ordinary skill in the art will recognize that additional embodiments are readily understandable and are a part of the example embodiments.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

I claim:

1. A protective enclosure for a device comprising:
a shell; and
a gasket configured to be disposed between the shell and a device;
wherein the shell comprises a shell orifice and the gasket comprises a corresponding gasket orifice;
wherein the shell is configured to press the gasket against the device, thereby exerting a compressive force on the gasket and creating a watertight seal around the perimeter of the shell and gasket orifices, preventing water from traversing that perimeter and entering the shell.

2. The protective enclosure of claim 1, wherein the shell and gasket orifices are configured to permit user interaction with at least a first interface of the device.

3. The protective enclosure of claim 2, wherein the first interface is a touch screen.

4. The protective enclosure of claim 1, wherein the shell orifice and the gasket orifice are configured to permit water to contact the device.

5. The protective enclosure of claim 1, wherein the shell and gasket are configured to allow water to contact a back of the device and a touch screen of the device.

6. The protective enclosure of claim 1, wherein the gasket is comprised of rubber, silicone or PVC.

7. The protective enclosure of claim 1, wherein the shell comprises a second shell orifice and the gasket comprises a rubber protrusion configured to extend through the second shell orifice and interact with a button of the device.

8. The protective enclosure of claim 1, wherein the device is at least one of a mobile telephone, computer, camera, tablet computer and media player.

9. The protective enclosure of claim 1, wherein the shell further comprises a second shell orifice associated with a second interface, and further comprising a waterproof assembly disposed beneath the second shell orifice and between the gasket and the shell that permits transmission of light or sound, wherein the waterproof assembly comprises a transparent window having an opening, waterproof fabric over the opening, and a plastic cover over the waterproof fabric and transparent window and wherein the transparent window, waterproof fabric, and plastic cover of the waterproof assembly are fused together and to the shell in a watertight fashion.

10. The protective enclosure of claim 1, wherein the shell comprises a first portion and a second portion.

11. The protective enclosure of claim 10, wherein the first portion or the second portion of the shell comprises a coupling protrusion and the other portion of the shell comprises a coupling notch, wherein the coupling notch is configured to receive the coupling protrusion to couple the first portion of the shell and the second portion of the shell and to apply compressive force to the gasket.

12. The protective enclosure of claim 11, wherein the first or second portion of the shell is configured to cover a back side of the device, and the other portion of the shell is configured to cover a front side of the device.

13. The protective enclosure of claim 10, wherein the first portion and the second portion of the shell comprise openings configured to receive screws and allow the screws to contact the gasket in positions that do not affect the watertight seal.

14. The protective enclosure of claim 1, wherein the shell has a thickness of 1 mm to 1.5 mm.

15. The protective enclosure of claim 1, wherein the gasket comprises an O-ring.

16. The protective enclosure of claim 1, further comprising a hinged door connected to the shell and configured to releasably connect to the shell and comprising a charge port gasket that forms a seal between the shell and a charge port when the hinged door is closed.

17. A protective enclosure comprising:
a shell comprised of a rigid material with at least one shell orifice configured to permit user interaction with at least a first interface of a device; and
a gasket comprised of a flexible material and including a gasket orifice corresponding to the shell orifice, the gasket configured to be disposed between the shell and the device, and configured to receive compressive force from the shell and the device along a perimeter of the shell orifice and the gasket orifice.

18. The protective enclosure of claim 17, wherein the gasket and the shell prevent water from traversing beyond a perimeter of the shell orifice and the gasket orifice.

19. A device protection method, comprising:
inserting a device in a protective enclosure, wherein the protective enclosure comprises a gasket fixed to the inside of a shell and has one or more orifices extending through the gasket and shell;
applying a compressive force to the gasket between the shell and the device, forming a waterproof seal around the perimeter of the orifices; and
exposing portions of the device to an environment.

20. The device protection method of claim 19, wherein exposing portions of the device to the environment comprises exposing one or more interfaces of the device to the environment.
